(19) United States
(12) Patent Application Publication
(10) Pub. No.: US 2013/0176937 A1
(43) Pub. Date: Jul. 11, 2013

(54) MULTIPLE ACCESS TRANSMISSION SCHEME FOR A WIRELESS SYSTEM

(71) Applicants: Alain Rolle, Gent (BE); Dirk Breynaert, Sint-Niklaas (BE); Daniel Delaruelle, Sint-Niklaas (BE)

(72) Inventors: Alain Rolle, Gent (BE); Dirk Breynaert, Sint-Niklaas (BE); Daniel Delaruelle, Sint-Niklaas (BE)

(21) Appl. No.: 13/825,297

(22) PCT Filed: Sep. 19, 2011
(86) PCT No.: PCT/EP2011/066239

§ 371 Date: Mar. 20, 2013

(30) Foreign Application Priority Data
Sep. 21, 2010 (GB) 1015801.2

(51) Int. Cl. H04W 72/04

(52) U.S. Cl. CPC H04W 72/0446
USPC 370/322

(57) ABSTRACT

A wireless multiple access communication system (5) comprises a forward link (31) to a terminal (40) and a return link (32) from a terminal (40). The return link (32) uses a medium which is shared between terminals (40) on the basis of time and frequency. A terminal (40) transmits a return link signal (32) from the terminal comprising a sequence of transmission slots (51, 52, 53). each transmission slot being defined as a time slot and, carrier frequency, wherein carrier frequency and symbol, rate can change between transmission slots. The return link signal (32) is transmitted continuously across the sequence of transmission slots (51, 52, 53). The terminal can transmit a return link signal (32) which is phase continuous across the transmission slots,

### FIELD OF THE INVENTION

This invention relates to a multiple access transmission scheme for a wireless system, such as the return link of an interactive satellite communication system and to apparatus for implementing the scheme,

### BACKGROUND TO THE INVENTION

A range of interactive satellite communication systems have been proposed. In this type of system, terminals receive data from a hub on a forward link and can also transmit data to the hub via a return link (return channel). Both the forward link and return link are transmitted via a satellite. A system of this kind is standardised as Digital Video Broadcasting-Return Channel via Satellite (DVB-RCS) ETSI EN 301 790.

DVB-RCS uses a medium which is multiplexed on a time-shared and frequency-shared basis between terminals. The scheme is called Multiple-Frequency Time-Division Multiple Access (MF-TDMA). MF-TDMA allows a group of terminals to communicate with a gateway using a set of carrier frequencies, each of which is divided into time-slots. A scheduler allocates to each active terminal a series of slots, each slot being defined by a frequency, a bandwidth, a start time and a duration. FIG. 1 shows one of the MF-TDMA schemes, called fixed MF-TDMA. A grid of time slots 10 is shown. The slots have the same duration and the same bandwidth. The arrows in FIG. 1 indicate a sequence of slots 11, 12, 13 assigned by the scheduler to one terminal in the system.

Another form of MF-TDMA is Dynamic-Slot MF-TDMA, This varies the bandwidth and duration of successive slots allocated to a terminal. In addition to changing carrier frequency and burst duration, the terminal may also change transmission rate and coding rate between successive bursts. The advantage of the more flexible terminal is more efficient adaptation to the widely varying transmission requirements typical of multimedia. FIG. 2 shows a sequence of slots 15, 16, 17 assigned by the scheduler to one terminal in the system, it can be seen that slot 16 has a wider bandwidth than slots 15 and 17. Slots 15 and 16 are longer than slot 17.

The types of MF-TDMA described in ETSI EN 301 790 have limitations m terms of bandwidth efficiency.

### SUMMARY OF THE INVENTION

An aspect of the present invention, provides a method of operating a terminal, in a wireless multiple access communication system comprising a forward link to the terminal and a return link from the terminal, wherein, the return link uses a medium which is shared between terminals on the basis of time and .frequency, the method comprising:

transmitting a return link signal from the terminal across a sequence of transmission slots, each transmission slot being defined as a time slot and carrier frequency, wherein carrier frequency and symbol rate cm change between transmission slots, and wherein the return link signal is transmitted continuously across the sequence of transmission slots.

The term “transmitted continuously” comprises: continuous transmission with zero guard time; continuous transmission with a small number of zero-energy, or reduced energy, transmission symbols at the beginning and/or end of a transmission slot. Advantageously, the return link signal is transmitted in a phase continuous manner across the sequence of transmission slots. This means that, even when the transmitted signal contains zero-energy (muted) transmission symbols, the duration of the period containing zero-energy transmission symbols is an integer number of transmission symbol periods.

Transmitting In a continuous manner avoids the need for a receiver to re-acquire the terminal signal each time the signal moves to a new frequency carrier and/or symbol rate, as the receiver can retain “lock” on a signal. This has an advantage of avoiding the need for a significant amount of overhead data, such as a long preamble provided for synchronisation purposes. Conventional transmission schemes transmit bursts with a significant guard time between bursts and require a significant amount of non-payload overhead data, such as a long preamble, in every transmitted burst, which is provided for the sole purpose of enabling receiver synchronisation.

The term “wherein carrier frequency and symbol rate can change between transmission slots” means that the carrier frequency and symbol rate can change between a contiguous pair of transmission slots, and that the terminal is capable of operating in this way. it will be appreciated that the method does not have to do change both carrier frequency and symbol rate between every pair of transmission slots. Depending on the particular pair of transmission slots, and the particular embodiment of the transmission scheme, the terminal may either: maintain earner frequency and symbol rate of the return link signal at the values used for the previous transmission slot; change just the carrier frequency of the return link signal compared to the value of carrier frequency used for the previous transmission slot; change just the symbol rate of the return link signal compared to the value of symbol rate used for the previous transmission slot; change the carrier frequency and the symbol rate of the return link signal compared to the values of carrier frequency and symbol rate used for the previous-transmission slot.

Advantageously, the method comprises receiving, on the forward link, information identifying a subsequent transmission slot The information allows the terminal to determine a number of transmission symbols to be transmitted during the subsequent transmission slot The information can specify a symbol rate, from which the terminal can determine a number of transmission symbols, or the information can specify a number of transmission symbols.

Advantageously, the method comprises transmitting at one of a set of different symbol rates, the set of symbol rates being related such that each of the set of symbol rates has an integer number of symbols during a slot period, and wherein the terminal changes symbol rate at a start of a new transmission slot.

Advantageously, the method comprises acquiring frequency synchronisation with the forward link and transmitting at a symbol rate and carrier frequency on the return link based on the acquired frequency synchronisation.

Advantageously, the method comprises acquiring synchronisation with a hub of the system by: receiving, from the hub, an instruction to start transmitting identification symbols on the return link; transmitting, on the return link, identification symbols and counting the number of transmitted identification symbols; receiving an instruction to begin, transmitting a user data payload in a first transmission slot, after a specified number of transmitted Identification symbols; and transmitting, in the first transmission slot, a user data payload after transmitting the specified number of identification symbols.

Advantageously, the method comprises receiving an instruction to adjust the symbol rate on the return link. The terminal can receive an instruction to increase, or decrease, the symbol rate. This ensures that the terminal remains in synchronism with the hub, without the need for the terminal to maintain a time reference.

A further aspect of the invention provides a method of operating a hub of a wireless multiple access communication system comprising a forward link from the hub to terminals in the system and a return link from a terminal to the hub, wherein return links from terminals share a transmission medium which is divided on the basis of time and frequency, the method comprising, at the hub:
allocating a terminal in the system a sequence of transmission slots, each transmission slot being defined as a time slot and. carrier frequency, wherein carrier frequency and symbol rate can change between transmission slots;
allocating a return link receive function for the reception of the return link signal from each terminal in the network; and,
causing the receiver to change in carrier frequency substantially in synchronism with a change in the carrier frequency of the signal received from the terminal, wherein the return link signal is transmitted continuously across the sequence of transmission slots.

Conventional MF-TDMA requires fine scheduling granularity, typically implying usage of short bursts, which implies that short error protection codewords should be used to fit in these short bursts. For a given available signal-to-noise ratio it is more difficult to design spectral efficient codes with short codewords than with long codewords. Advantageously, in embodiments of the present invention there is continuous transmission (i.e. no ‘bursts’), so codeword lengths can be determined by a tradeoff between allowable processing delay and desired spectral efficiency versus signal-to-noise ratio, as is known in the art, without or with very little hinder from the MP-TDMA context. Thus, embodiments of the present invention improve overall spectral efficiency due to: more efficient codes (longer codewords) and less overhead since there is no guard time between slots and moreover for a given amount of transported payload data, less preamble is needed for synchronisation purposes. A further advantage of the substantial continuous transmission is that a signal can be monitored easily with respect to the terminal outdoor unit saturation. Saturation monitoring enables saturation prevention, which in turn allows using an outdoor unit power amplifier very close to saturation instead of taking unduly large power backoff thus allows using an outdoor unit very efficiently. Saturation monitoring is very difficult for the short burst durations typically used in classical MP-TDMA.

Further aspects of the invention provide apparatus for performing any of the described or claimed methods, in particular, an aspect of the invention provides a wireless communication terminal for use in a wireless multiple access communication system comprising:
a receiver arranged to receive & forward link signal; and
a transmitter arranged to transmit a return link signal, wherein the return link uses a medium which is shared between terminals on the basis of time and frequency, and wherein the transmitter is arranged to transmit a return link signal from the terminal comprising a sequence of transmission slots, each transmission slot being defined as a time slot and, carrier frequency, wherein carrier frequency and symbol rate can change between transmission slots, and wherein the return link signal is transmitted continuously across the sequence of transmission slot.

Another aspect of the invention provides a wireless communication, apparatus for use at a hub of a wireless multiple access communication system comprising:
a transmitter arranged to transmit a forward link to terminals in the system;
a receiver arranged to receive a return link signal from each one of the terminals, wherein return link signals from terminals share a transmission medium which is divided on the basis of time and frequency;
a scheduling function arranged to schedule a sequence of transmission slots for the return, link of each terminal, each transmission slot being defined as a time slot and, carrier frequency, wherein carrier frequency and symbol rate can change between transmission slots;
causing the receiver to change in frequency substantially in synchronism with a change in the frequency of the return link signal received from the terminal, wherein the return link signal is transmitted continuously across the sequence of transmission slots.

The system can have any one of the following topologies: star; multi-star; partly meshed star network where terminal-to-hub and terminal-to-terminal communication links can share bandwidth.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect, of the invention provides machine-readable Instructions (software) which, when executed by a processor, perform any of the described methods. The machine-readable instructions may be stored on an electronic memory device, hard disk, optical disk or other machine-readable storage medium. The machine-readable instructions can be downloaded to the storage medium via a network connection.

### BRIEF DESCRIPTION OF TOE DRAWINGS

Embodiments of the invention will be described, by way of example only, with reference to the accompanying drawings in which:

FIG. 1 shows a conventional MF-TDMA scheme;

FIG. 2 shows another conventional MF-TDMA scheme;

FIG. 3 shows an interactive satellite communication system according to an embodiment of the present invention;

FIG. 4A shows a transmission scheme according to an embodiment of the present invention;

FIG. 4B shows a transmission scheme according to another embodiment of the present invention, with fixed slot duration;

FIG. 4C shows a transmission scheme according to another embodiment of the present invention, with fixed slot duration and frequency grid;

FIG. 5A shows operation of a terminal according to a conventional MF-TDMA transmission scheme;

FIG. 58 shows operation of a terminal using a transmission scheme according to an embodiment of the present invention;

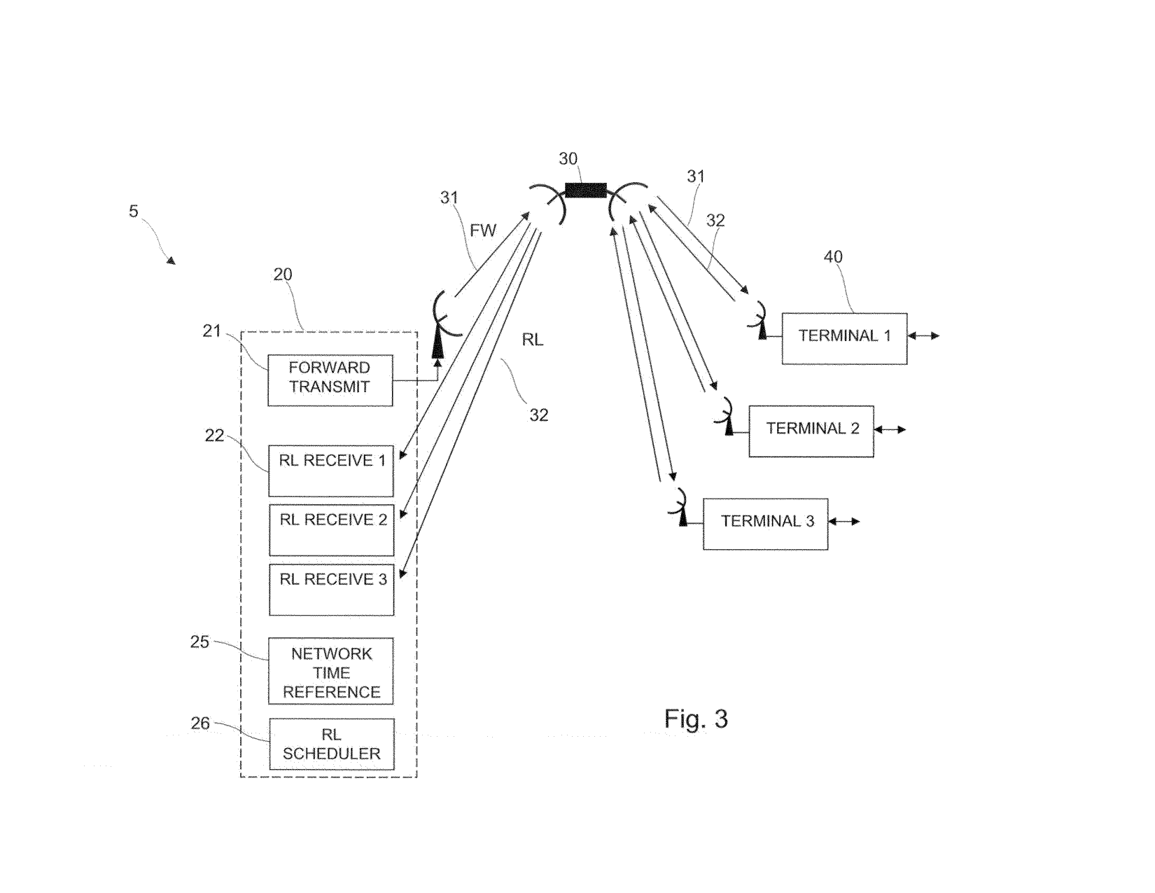

FIG. 6 shows a state diagram of a terminal in the system of FIG. 3;

FIG. 7 shows operation of the hub and a terminal in the system of FIG. 3;

FIG. 8 shows an example structure of a physical layer frame;

FIG. 9 shows a baseband signal generated by a terminal;

FIG. 10 shows apparatus at a terminal of the system of FIG. 3;

FIG. 11 shows apparatus at a hub of the system of FIG. 3.

### DESCRIPTION OF PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Furthermore, the terms first, second, third and the like in the description and in the claims, are used for distinguishing between similar elements and not necessarily tor describing a sequential or chronological order. It is to he understood that the terms so used are interchangeable under appropriate circumstances and that the embodiments of the invention described herein are capable of operation in other sequences than described or illustrated herein.

FIG. 3 shows an interactive satellite communication system 5 according to an embodiment of the present invention. The main entities of the communication system 5 are a hub 20, a satellite 30 and terminals 40. The hub 20 comprises a forward link transmit function 21 and a set of receivers 22 for receiving signals from terminals 40 on return links 32. in use, the forward link transmit function 21 transmits a forward link (FW) signal 31 to satellite 30, and the satellite 30 retransmits the forward link signal 31 to terminals 40. Bach active terminal 40 transmits a return link (RL) signal 32 to satellite 30, and the satellite 30 retransmits the return link signal 32 to receivers 22 at the hub. Advantageously, there is a receiver allocated to receive the return link signal 32 from each active terminal 40. The hub also comprises a network time reference 25. A return link, scheduler 26 allocates transmission slots to terminals 40 based on traffic requests received from terminals 40 and based on perceived return link quality (e.g. signal to noise ratio) on every terminal to hub link. Scheduler 26 transmits information to terminals, via the forward link 31. identifying which transmission slots a terminal 40 should use to transmit their data. The system 5 is effectively a star network, servicing N users (N=3 in FIG. 3) through the hub 20. A terminal 40 can he an indoor unit or an outdoor unit. The forward link (FW) 31 from the hub 20 to terminals 40 is typically a single broadband carrier carrying information to all users by means of a time-sharing mechanism such as Time-Division Multiple Access (TDMA).

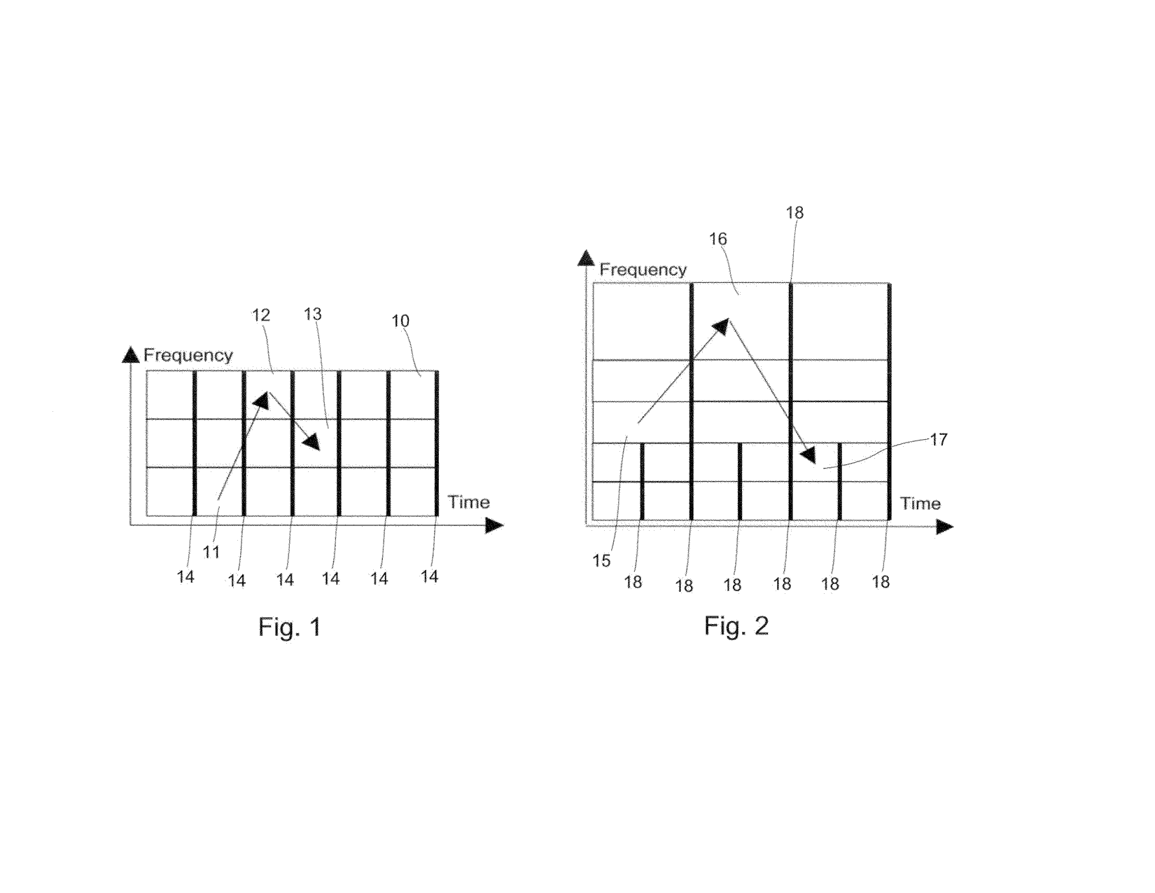

In embodiments of the present invention, the access medium is shared between all return links 32 by means of Multiple-Frequency Time-Division Multiple Access (MF-TDMA). At every single time Instant the transmitted signals of all terminals (users) 40 are separated in frequency and the frequency and width of spectrum occupied by each terminal is subject to change over time. Accordingly, it can be seen that the transmission scheme Is a combination of Frequency Division Multiple Access (FDMA) and Time Division Multiple Access (TDMA). However, in contrast to conventional MF-TDMA systems, a terminal 40 transmits continuously, and does not use a conventional guard time interval in between transmissions at different frequencies and symbol rates. The conventional guard time interval is shown in the prior art schemes of FIGS. 1 and 2 as bold lines 14, 18.

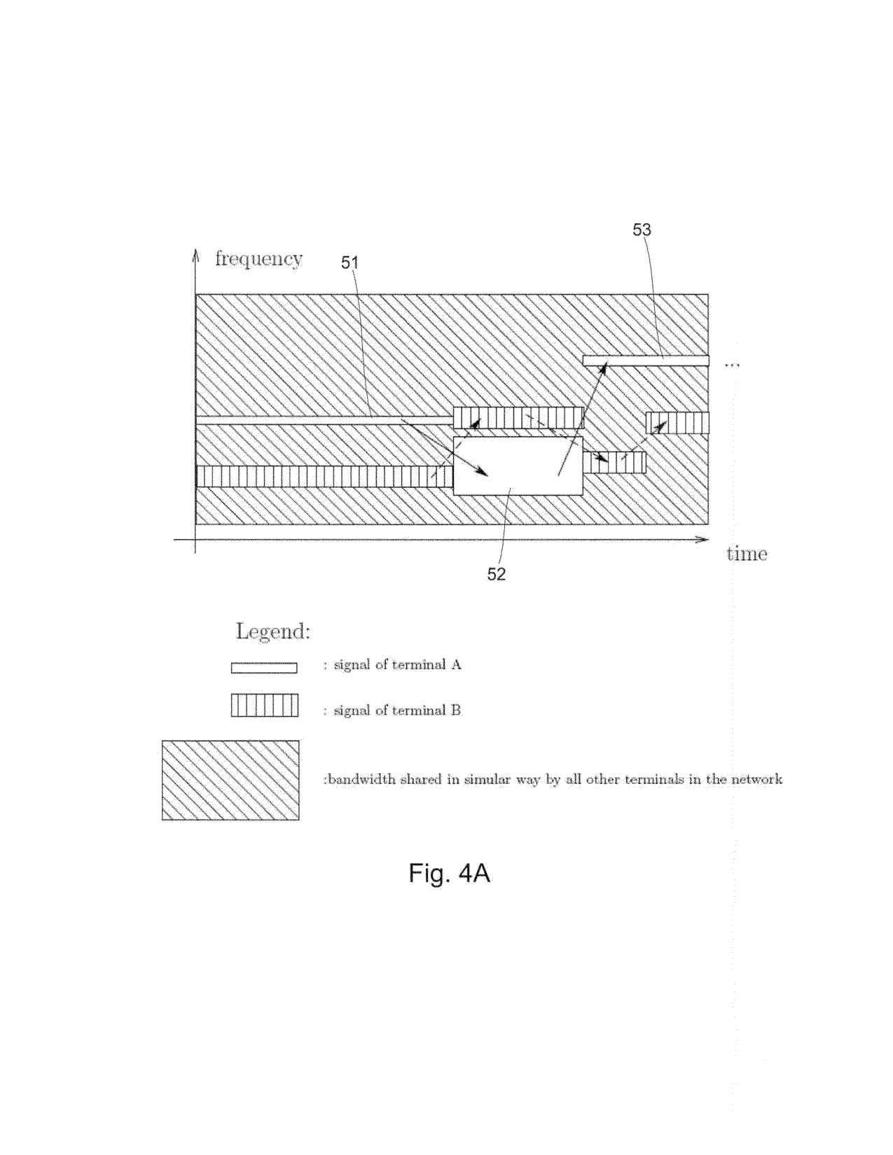

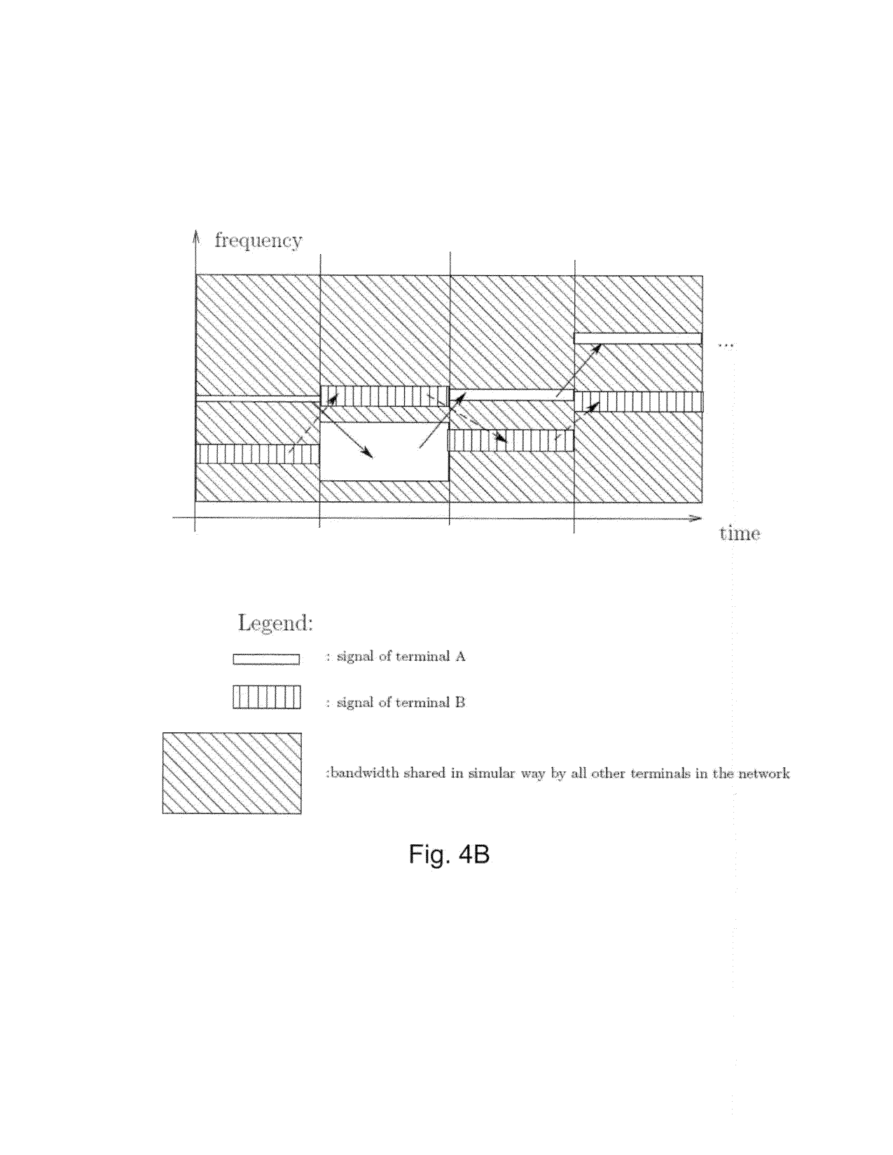

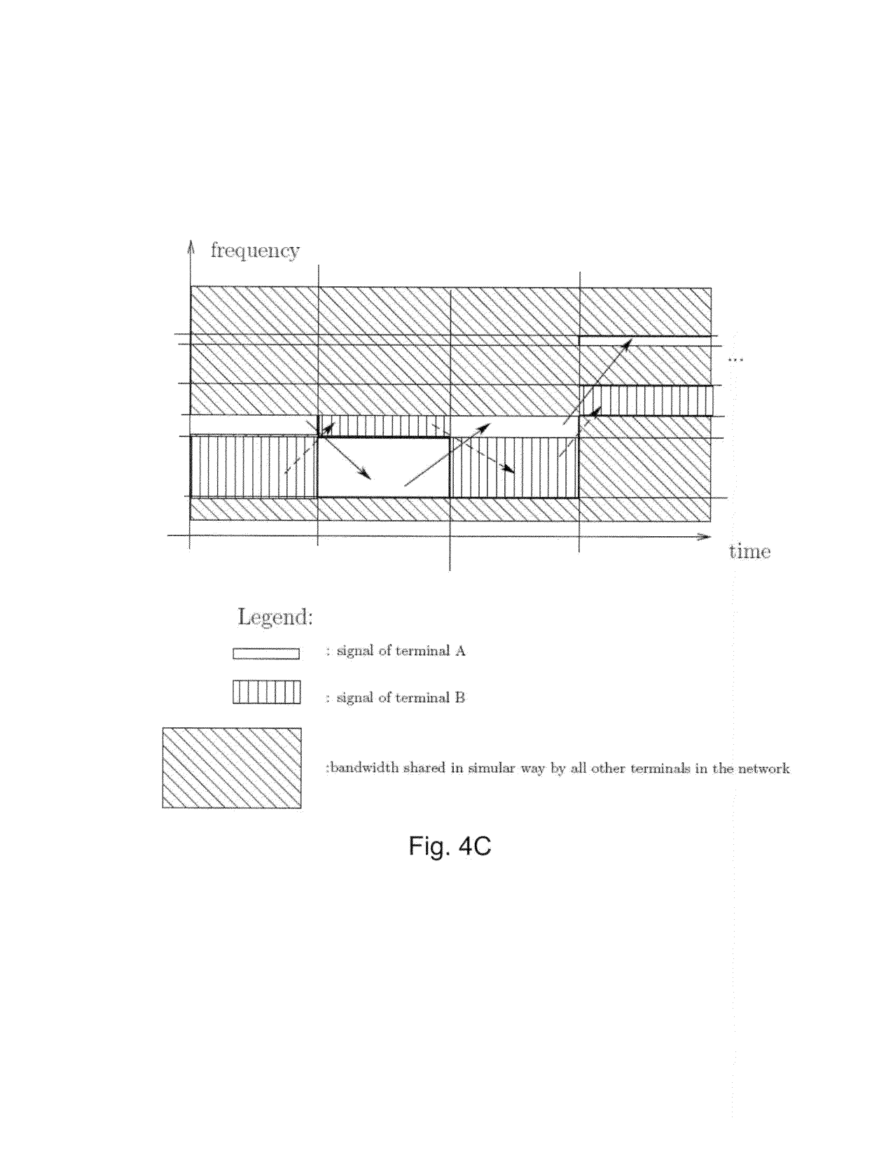

FIGS. 4A-4C show transmission schemes according to embodiments of the present Invention. For clarity, each Figure shows a sequence of transmission slots assigned to two terminals (Terminal A, Terminal B). It will be understood that other terminals can operate at the same time as these terminals, using other transmission slots which differ in time and frequency to the slots assigned to Terminal A and Terminal B.

In the scheme of FIG. 4A, a terminal transmits across a sequence of transmission slots. The slots vary in duration. The slots also vary in bandwidth, allowing the terminal to transmit at different symbol rates. There is no rigid allocation of frequency carriers to transmission slots of a particular symbol rate. Terminal A transmits across a sequence of transmission slots 51, 52, 53.

In the scheme of FIG. 4B, a terminal transmits across a sequence of transmission slots of equal, fixed, duration. The slots do not vary in duration. The slots vary in bandwidth, allowing the terminal to transmit at different symbol rates. There is no rigid allocation of frequency carriers to transmission slots of a particular symbol rate.

In the scheme of FIG. 4C, a terminal transmits across a sequence of transmission slots of equal, fixed, duration. The slots do not vary in duration. The slots vary in bandwidth, allowing the terminal to transmit at different symbol rates. However, frequencies are assigned to slots of a particular bandwidth.

Although, advantageously, transmission slots are fully separated in both frequency and time, it is possible for there to he some controlled frequency overlap between transmission slots. This will incur some loss in error performance (e.g. increased bit error rate or packet loss). There can be some frequency overlap between transmission slots to the extent that the error the overlap causes is acceptable to the network operator.

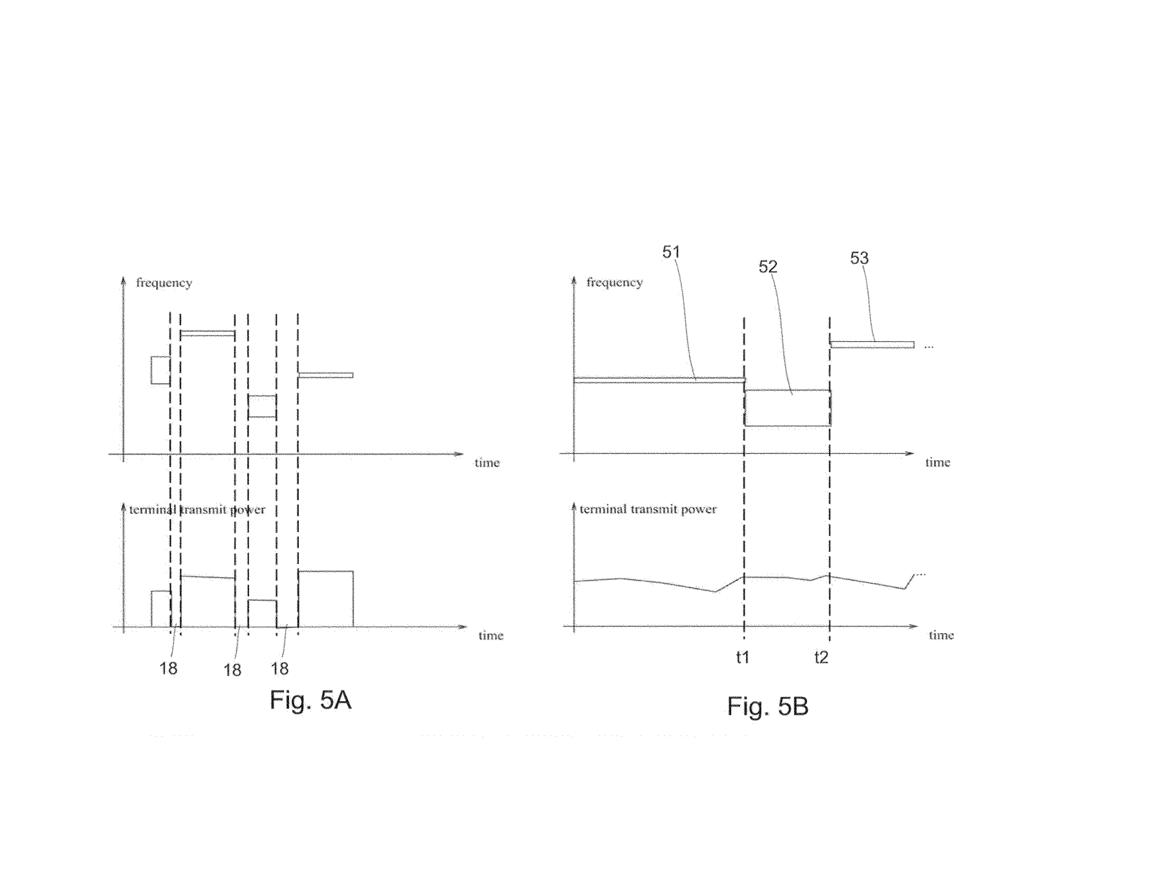

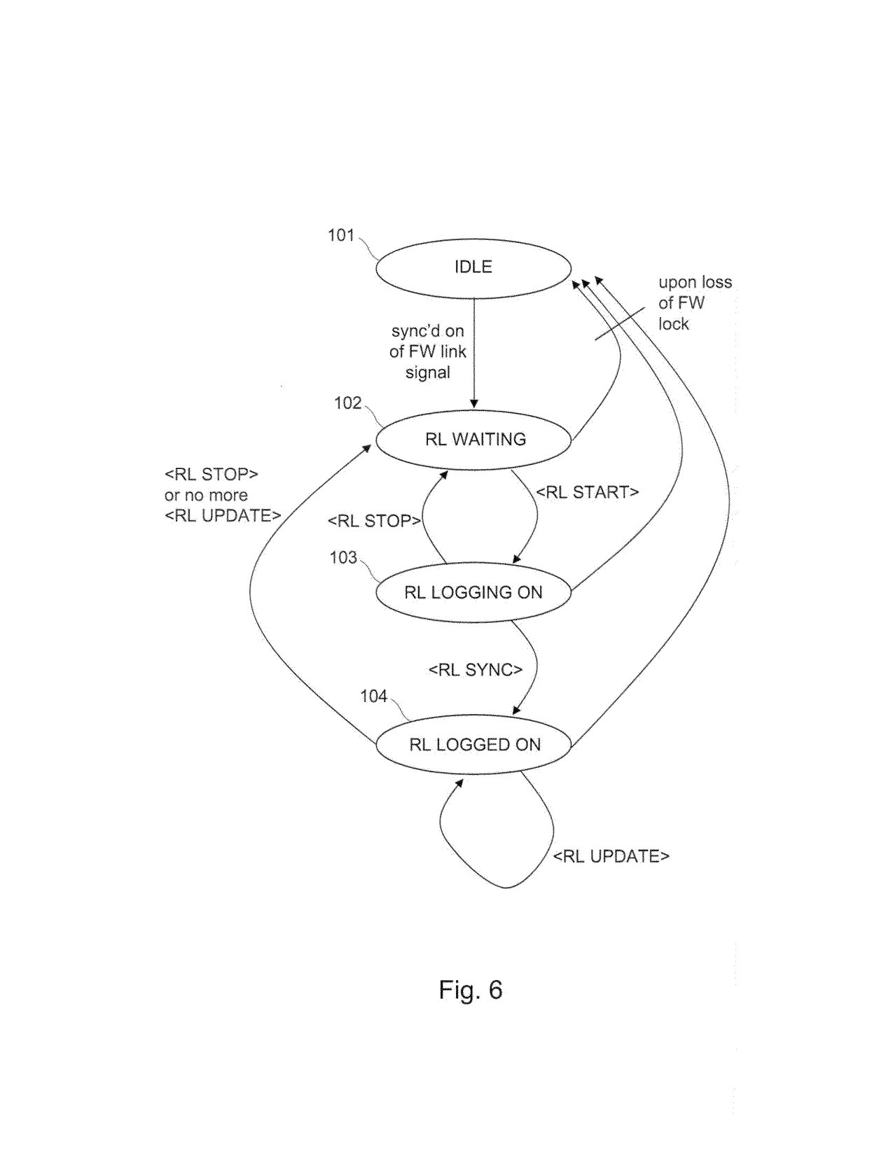

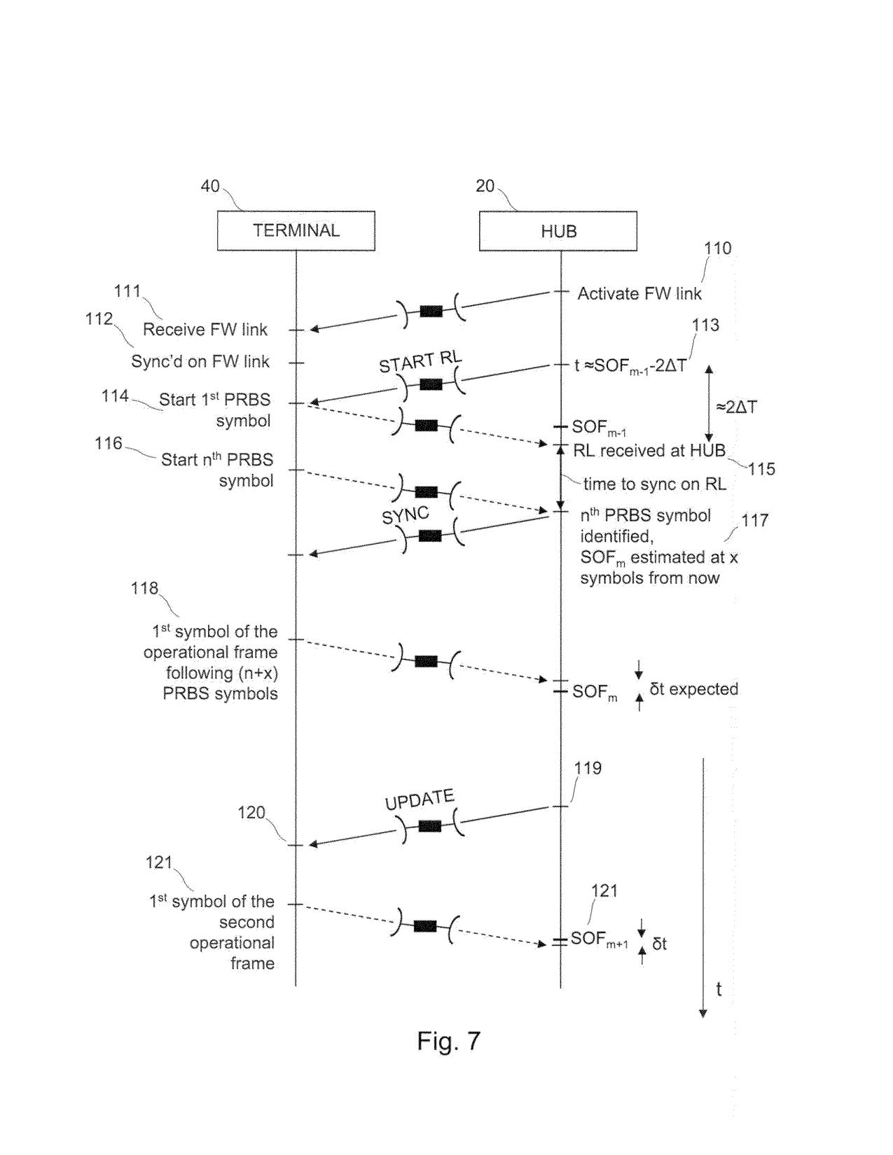

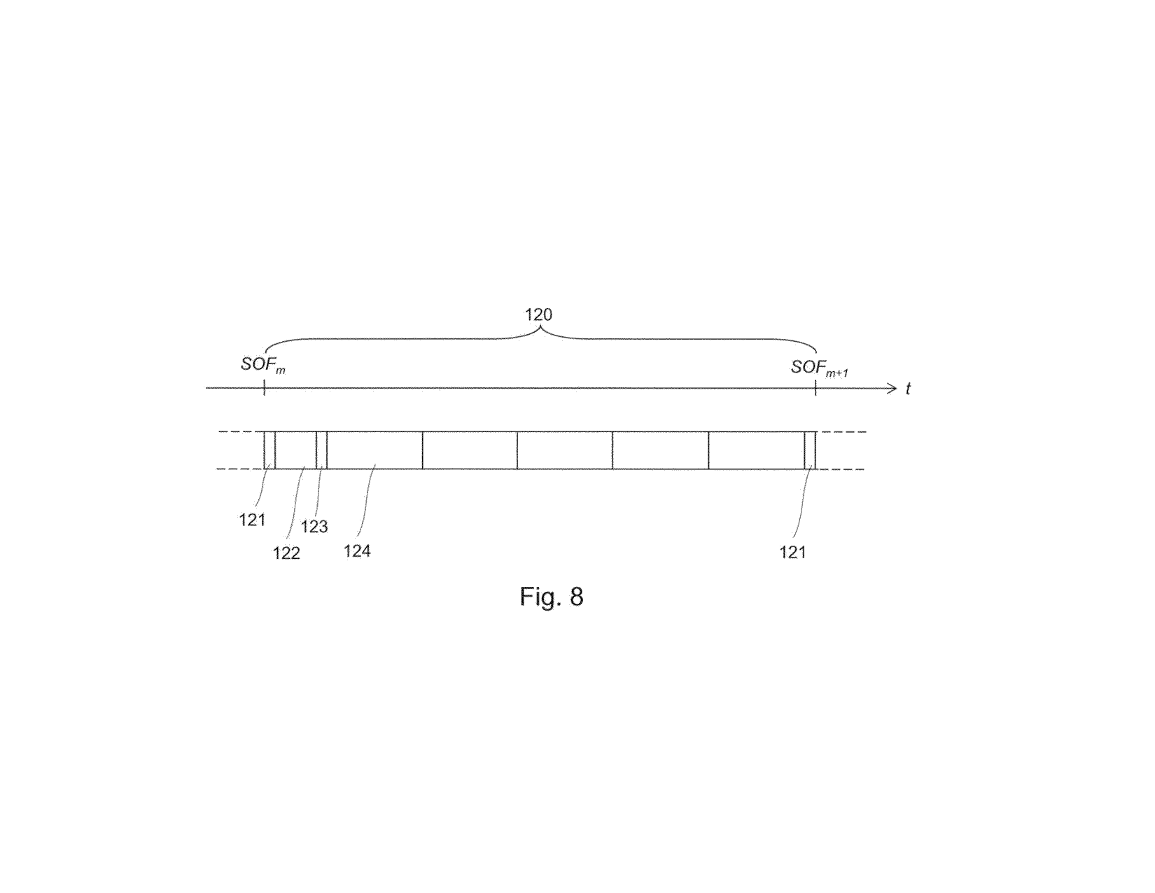

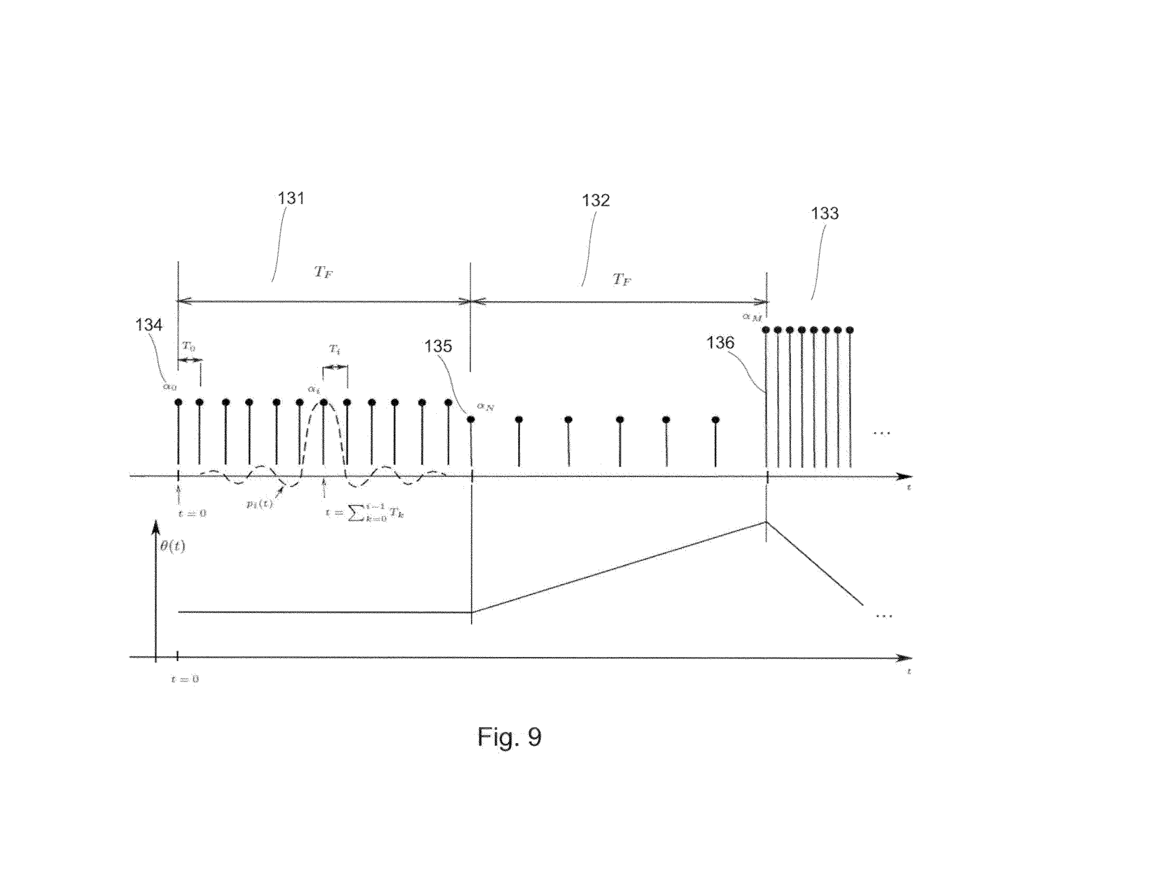

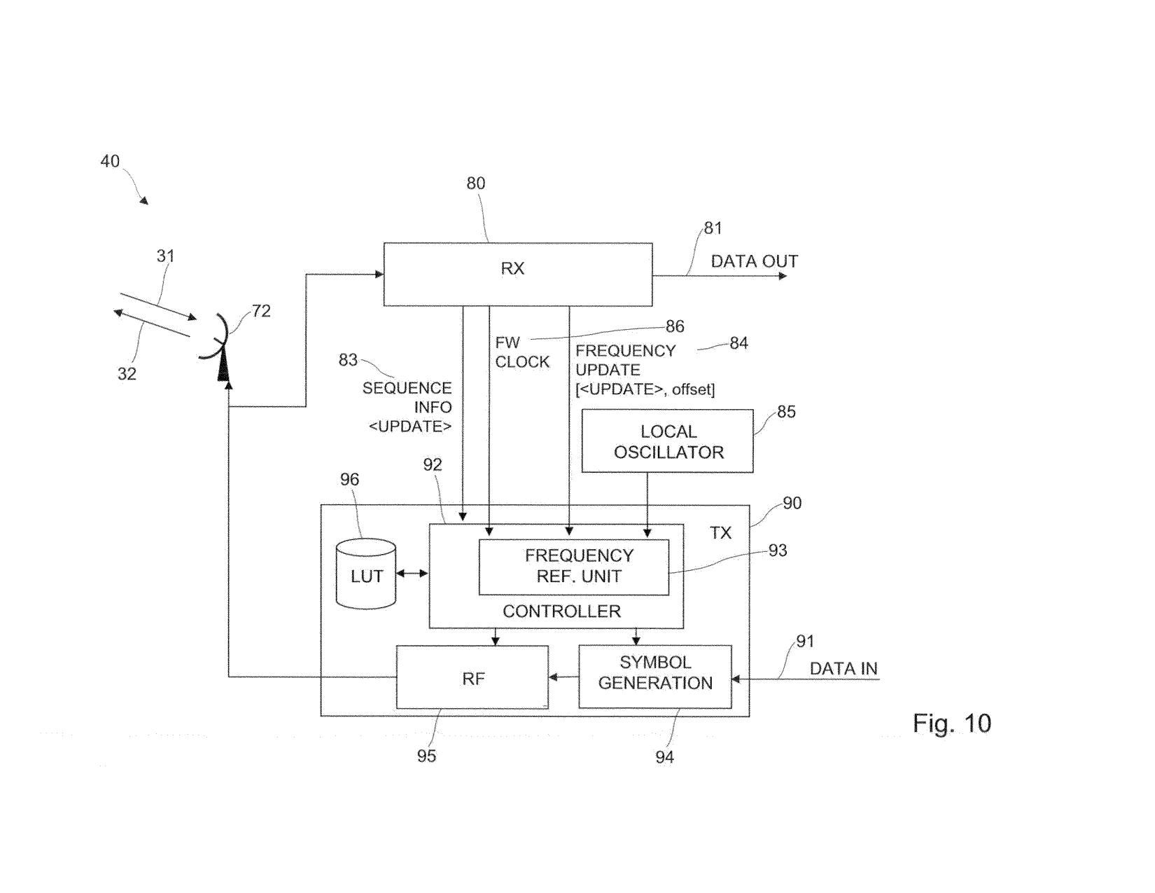

FIGS. 5A and 5B show the return link signal transmitted by an individual terminal over a period of time. FIG. 5A shows a conventional MF-TDMA terminal, and FIG. 5B shows a terminal which operates according to an embodiment of the present invention. FIG. 5A shows a graph of frequency against time, for a return link (RL), illustrating transmission slots of a single conventional dynamic-slot MF-TDMA terminal. FIG. 5A also shows a graph of possible power against time of a conventional MF-TDMA terminal over the same time period.

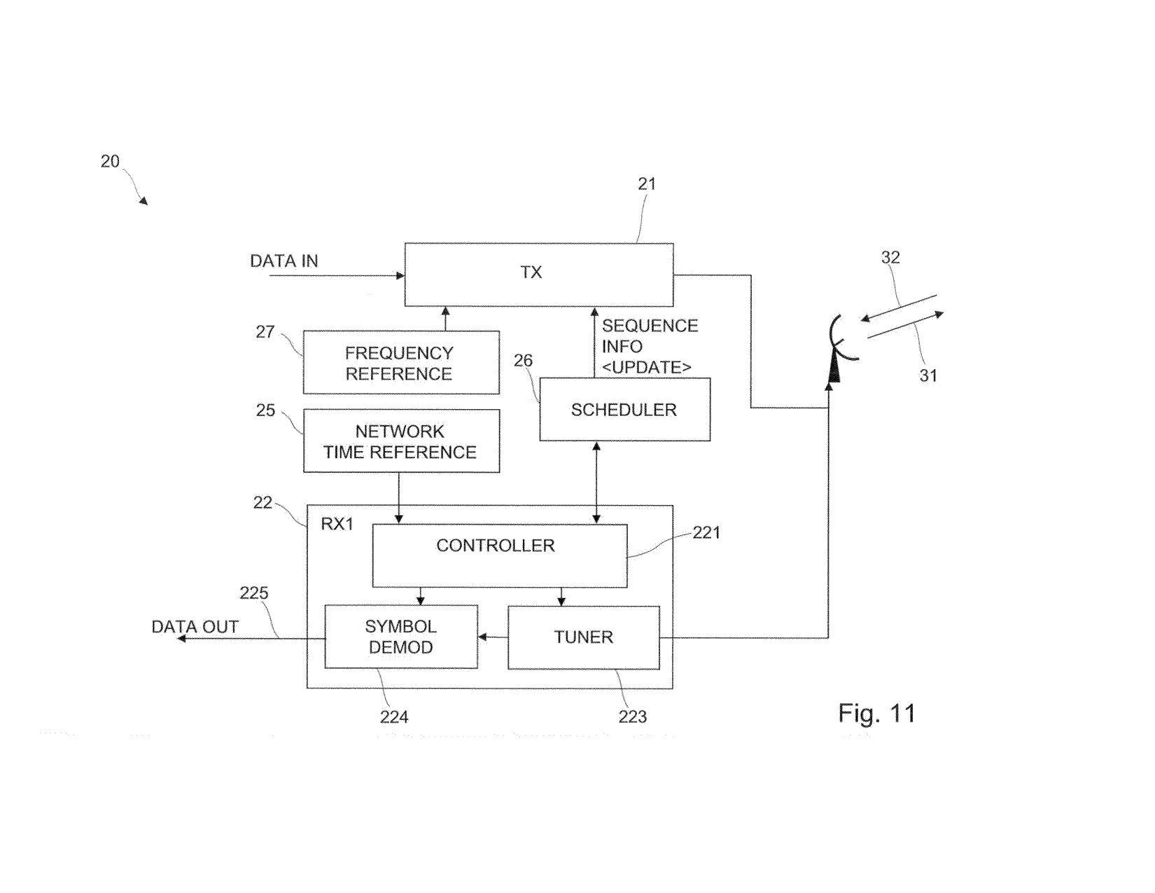

FIG. 5B shows a graph of frequency against time for a reverse link (RL), illustrating a sequence of transmission slots 51, 52, 53 of a single terminal 40 according to an embodiment of the Invention. FIG. 5 also shows a graph of possible power against time over the same time period. The power level can vary during a transmission slot (as shown, in FIG. 5B) or the power level can remain constant. The transition between transmission slots at times t1 and t2 is substantially immediate and does not interrupt the transmitted signal FIG. 5B also shows that bandwidth of the reverse link signal transmitted by a terminal 40 can vary between slots. Bandwidth of slot 52 is greater than the bandwidth during slots 51, 53. FIG. 58 also shows that the duration, of a transmission slot can vary between slots, although it can be advantageous for ease of operation to choose a single fixed transmission slot duration value. Terminals 40 do not change transmit frequency or symbol rate (occupied spectrum) without prior knowledge of the hub 20. In an embodiment, the return link time-and-frequency plan is periodically revised by the scheduler 26 at the hub 20 and communicated via the forward link 31 to each terminal 40.

A hub in the system 5 knows in advance, and to a sufficient accuracy, when to expect frequency changes and/or symbol rate changes In a return link. Terminals change frequency and/or symbol rate at instants synchronised to the transmit symbol clock, these instants being dictated in advance by the hub. This allows the hub to anticipate and counteract frequency changes such that, the hub stays synchronised to the return link signal, without the need to re-acquire lock onto the terminal signal after a carrier frequency or symbol rate transition, as would normally occur in MF-TDMA burst receivers.

Advantages of a transmission scheme with continuous transmission include: optimum usage of satellite channel capacity (in terms of achievable bits/s/Hz); minimum receiver hardware complexity, and thus: cost, for a given total return link bandwidth to be processed.

The process of synchronising terminals will now be described in detail. System synchronisation ensures continuous communication between the hub 20 and every individual terminal, as well as minimum interference between the RL signals 32 transmitted by terminals 40 in the system. It also prevents transmission regulation violations. The system synchronisation mechanism supports variable RL symbol rate and RL carrier frequency. The system synchronisation mechanism is also sufficiently robust to cope with typical channel parameter statistics encountered in a satellite channel, e.g. terminal oscillator accuracy and drift, satellite local oscillator accuracy and drift, propagation delay variations due to satellite movement (resulting in a time variable roundtrip time), and propagation delay variations in the footprint of the satellite.

Each terminal 40 acquires frequency synchronisation with a stable common reference in the system. This has two purposes. Firstly, once a hub demodulator has acquired the signal of one terminal 40 on a transponder (and thus has established the satellite LO frequency offset which can amount to order of some 100 kHz), the frequency uncertainty on the other terminals transmitting in this transponder will be limited to the order of some kHz. This fact helps reducing the network boot time. Secondly, this guarantees that the terminal carrier frequency respects transmit regulations over time. In an embodiment of the invention, a GEO satellite is used and the forward link (FW) symbol clock is treated as the reference in the system. Every terminal receives the FW link 32, and thus automatically tracks and ‘knows’ the effective FW symbol clock. Thus a terminal can synthesize any other frequency by considering the received symbol clock as a reference. The expected doppler and doppler rate effect on the symbol rate results from periodic variations in. hub-satellite-terminal distances. For GEO satellites, this amounts to a negligible periodic excursion from the nominal symbol rate.

A terminal 40 has four operating modes or states 101-104, shown in the state diagram of FIG. 6. FIG. 7 shows a timeline of communication between the hub 20 and a terminal 40. At time 110, the hub 20 starts transmitting a forward link signal. The terminal 40 starts in the ‘IDLE’ state 101 and remains in that state until it is frequency slaved to the tracked forward link symbol clock. The terminal receives the FW link at time 111 and acquires frequency synchronisation at time 112. When the terminal is synchronised it receives RL Look-Up Tables in the FW link signal. These tables contain information about the finite set of permitted RL frame structures (coupled to the finite set of nominal RL transmission rates). When these conditions are satisfied, the terminal enters the ‘RL WAITING’ state 102. Terminal TX circuitry is muted while in the ‘IDLE’ state 101 or ‘RL WAITING’ state 102.

The terminal remains in the ‘RL WAITING’ state 102 until it has received a <RL START> signal from the hub 20 indicating the RL carrier frequency plus indoor unit power level at which it may start transmitting an identification sequence. A suitable identification sequence is a Pseudo-Random Binary Sequence (PRBS) with a given polynomial and initial state. The hub transmits the <RL START> signal at time 113. Upon reception of this <RL START> signal, the terminal enters the ‘RL LOGGING ON’ state 103 and stasis transmitting (time 114) the PRBS symbol sequence at the requested carrier frequency. In an embodiment, the PRBS sequence is BPSK modulated. That is, the terminal transmits BPSK symbols which represent the PRBS sequence. The terminal 40 continues transmitting this PRBS sequence, while keeping track of the number of already transmitted PRBS symbols, until at some point it either receives a <RL SYNC> message or a <RL STOP> message from the hub 20. The hub sends the <RL SYNC> message at time 117. The <RL SYNC> message indicates that the hub 20 was able to sync to the signal sent by the terminal, and identifies how many PRBS symbols the terminal must have transmitted in total, before it may send the very first symbol of the first operational frame. This first symbol will be called the Start of Frame (SOF) symbol. Upon reception of the <RL SYNC> message, the terminal enters the ‘RL LOGGED ON’ state 104.

At any time the hub 20 may decide to send a <RL STOP> message, which causes the terminal to mute its transmitter and brings it back into the <RL WAITING> state. The hub 20 could, for example, send a <RL STOP> message while the terminal 40 is still in the ‘RL LOGGING ON’ state 103 because the HUB fails to lock to the RL signal from this terminal.

In ‘RL LOGGED ON’ slate 104, the terminal 40 transmits Its first frame carrying real payload after having sent the required number of PRBS symbols as communicated in the <RL SYNC> message. All parameters required to completely define the first frame are contained in the <RL SYNC> message. These include symbol rate, modulation and coding scheme for the payload (called modcod), carrier frequency, power level. If the terminal is required to change symbol rate and/or carrier frequency at the first symbol of the operational frame, it does this in a phase continuous fashion, synchronised to the SOF symbol.

The terminal leaves the ‘RL LOGGED ON’ state 104 for the ‘RL WAITING’ state 102 if it receives a <RL STOP> message from the hub (this can be the consequence of a bandwidth management decision from the hub scheduler, or simply because the hub can no longer synchronise to the terminal's signal and wants it to shut down for safety reasons).

While in ‘RL LOGGED ON’ state 104, the terminal must receive an <UPDATE> message from the hub prior to having sent all required symbols of the current frame. At 119 the hub sends an <UPDATE> message which Instructs the terminal 40 about signal parameters to be used as from the next SOP symbol. The parameters include: carrier frequency, symbol rate, modcod, power. The <UPDATE> message is received at the terminal at 120. At 121, the terminal transmits the first symbol (SOF) of the second operational frame. The hub 20 receives this SOF symbol at 121. The <UPDATE> message also conveys to the terminal that the hub Is still alive. If the RL demod function in the hub should tail unexpectedly, it will send no more <UPDATE> messages and the terminal returns to the <RL WAITING> state 102. Regardless of the actual terminal state, loss of lock on the FW link 31 is a cause to switch immediately back to ‘IDLE’ state 101.

To summarise the process described above, a terminal 40 is initially synchronised to the frame, or heartbeat, of the overall system by maintaining a count of the number of transmitted PRBS symbols and uses this count, and the information received from the hub 20 in a <SYNC> message, to time the start of the first symbol of an operational frame. Subsequently, the terminal can receive an instruction to apply a correction to the symbol rate, to ensure that symbols from the terminal arrive at the hub 20 at a required time. It can be seen that the time offset δt between the time at which the hub receives SOF symbol SOFₘ₊₁, and the actual time of SOFₘ₊₁, is already shorter titan for SOFₘ, and this time offset δt should converge towards substantially zero once the terminal has been logged on for a while.

### HUB Behaviour

The hub's notion of time will be called t_{H}. We can e.g. assume that t_{H} has the interpretation of seconds, counting from, minus infinity to plus infinity. A common hub reference time is distributed to all receivers in a hub 20. Notice that it is not required to distribute the hub time to the terminals, nor Is it required for a terminal to maintain a notion of time, in contrast with common practice in MF-TDMA networks. Dynamic RL parameter adjustments are applied on a heartbeat equal to the frame rate. The system frame duration shall be denoted as T_{F} (example order of magnitude: 1 second). All RL receivers 22 know the sequence of values t_{H}SOFₘ₋₁; SOFₘ; SOFₘ₊₁, . . . that correspond to frame boundaries. When the system is properly synchronised, the SOF symbols sent by all terminals 40 arrive at the hub receive antenna more or less at a time known to the hub as a frame boundary. This is possible, despite the fact that all terminals may transmit at different symbol rates, because only a finite set of nominal symbol rates is supported in the RL. Moreover, the exact frame duration is chosen such that an integer number of symbols fits in the frame duration for all permitted nominal symbol rates.

As described above, the hub activates the RL of an individual terminal by sending it a <RL START> message. The hub assumes the terminal is properly synchronised to the FW link, and thus will promptly react to the activation message. For a terminal to send its first real frame at t_{H}=SOFₘ, the hub is required to send the activation signal <RL START> at about t_{H}=SOFₘ₋₁−2ΔT, where 2ΔT is the round-trip transmission delay (hub to satellite to terminal to satellite to hub). When doing so, the hub can activate a corresponding demodulation process at a receiver to start signal acquisition attempts as soon as T_{H}=SOFₘ₋₁.

When a demodulation process at a receiver 22 is properly synchronised to the signal emitted by a terminal. It is at some point able to identify a certain received PRBS symbol as being the n-th symbol of the PRBS sequence. The receiver 22 knows the hub time associated to this n^{th} symbol. The receiver 22 also knows the hub time of the next due SOF event (in FIG. 7 this is SOFₘ). The receiver 22 calculates the time difference between the next SOF and hub time associated to this n^{th} PRBS symbol. This time difference can be translated (rounded) to an integer number of symbols (say x symbols). By means of a <SYNC> message, the receiver now Instructs the terminal to send a total of (n+x) PRBS symbols prior to sending the first real SOF symbol of an operational frame carrying a payload of data. The receiver continues tracking the terminal's signal and now assumes that the first SOF symbol of the first payload-carrying frame will be found x symbols later than the symbol identified as the n^{th} PRBS symbol. As such, it also knows to switch its nominal carrier and symbol clock frequencies, in a phase continuous manner, to the new values after having received and counted (n+x) PRBS symbols. Note that this mechanism ensures that the first SOF symbol will be received roughly at hub time SOFₘ. The error δt is largely due to the rounding operation involved when determining the nearest integer value x.

Once a terminal is properly logged-on, the synchronisation between this specific terminal and the hub 20 is based on counting symbols, either transmitted symbols or received symbols. Both the hub and the terminal have access to a static Look-Up Table (LUT) which specifies, for every (modcod, symbol rate) combination, how many symbols should be transmitted (or received) in a frame 10. Thus both terminal 40 and receiver 22 know when to inject/expect the next SOF symbol.

For as long as a terminal is logged on, the hub signals during the current frame period which RL parameters (modcod, symbol rate, carrier frequency, power) should be used as from the next SOF symbol onward. This is achieved by means of <UPDATE> messages shown in FIG. 7. Associated with every <UPDATE> message is the knowledge how many symbols should be transmitted/received in the next frame. The hub sends an <UPDATE> message more than 2ΔT+ε in advance of the next upcoming frame boundary, where ε is a suitable margin. If a terminal has not received a new <UPDATE> message when all symbols of the current frame have been sent, it assumes that the HUB RL process is in error and reverts to the ‘RL WAITING’ state 102 out of precaution.

For as long as a terminal is logged on, the hub receiver 22 compares the tracked terminal carrier frequency to the nominally expected value. This information is only used tor system health monitoring.

A hub demodulation process typically tracks every individual terminal's signal in closed carrier loop, thus natively copes with frequency drift very well without introducing extra complexity.

Advantageously, the PRBS sequence used by frequency-neighbouring terminals during the log-on process use different PRBS polynomials.

So far, it has been described how an individual RL 32 between a specific terminal and the HUB can remain synchronised essentially by counting symbols on either side of the link. The following describes how the RL signals of all terminals can be made to change carrier frequency and symbol rate more or less simultaneously, so as to minimise interference amongst the terminals 40. At all times a hub receiver compares the measured hub-time of a tracked SOF symbol to the target SOF time defined by the hub. This time difference can vary for several possible reasons. In order for the difference to converge towards zero, the ‘next symbol rate’ value in the <UPDATE> message comprises a nominal value (belonging to a known permitted finite set) and an offset value (typically a few ppm of the nominal value). This means that even when the hub scheduler momentarily does not request for a nominal symbol rate change, the hub receiver 22 may have observed a time skew trend and request, via the offset field, a symbol rate increment/decrement that will compensate a fraction of this skew over a frame's length.

The purpose of this slow time correction loop over the satellite Is to improve the SOF alignment of all terminals over time, as well as to compensate for long-term symbol clock drift. Initially, the SOF time error with respect to target will be large due to the rounding operation to a nearest integer number of symbols in the terminal log-on phase. After a while, the time correction loop will have reduced the offset to expected variations due to satellite movement Post log-on, terminal SOF deviation with, respect to hub SOF is assumed to be statistically uncorrelated between terminals. Alter a while, the log-on rounding error towards nearest integer number of symbols x no longer determines the deviation. The prime causes of deviation are then the time variable transmission delay ΔT and the jitter induced by the operation of the SOF-alignment loop. The peak-to-peak deviation over the terminal population will cause short-lived interference between terminal signals around SOF events. To mitigate this, it is advantageous for the SOF symbol and last, symbol of an operational frame to be zero-energy symbols. This way, the RL frequency plan is reshuffled while the RL is momentarily muted. The muting is performed in a clean spectral way, because muting occurs before a pulse-shaping filter. When required, terminal signal level can also be adjusted in between zero-energy symbols to maintain a given power spectral density despite potential symbol rate changes.

Advantageously, the system 5 periodically revises the return, link frequency plan and sends this information (the sequence information) to all terminals 40. The time between revisions is called a heartbeat period and can take a value of the order of, for example, 500 ms−1 second. Advantageously, the heartbeat is (exactly) equal to an integer number of channel symbol periods, regardless of the RL symbol rate in use. This, in turn, requires limiting available return link symbol rates to a finite set of discrete supported symbol rates, such that the heartbeat period is expressable as an integer number of symbols for every symbol rate in the finite set. The system has a dynamic RL, where multiple terminals share the same frequency band but individually change their spectral occupation (centre frequency and/or occupied bandwidth) over time. Terminals are controlled such that changes in spectral occupation by all terminals occur at substantially the same time. If this requirement is not met, demodulation of every given RL, signal will be seriously hindered by (frequency-)interfering signals from other terminals. One way to assure system synchronisation is by defining a common heartbeat for all return links 32. This heartbeat is the frame rate 1/T_{F}. Terminals are only allowed to change their spectral occupation at the Start of a new Frame (SOF). Thus, once every T_{F} seconds. The system synchronisation algorithms described above require this frame duration T_{F} to nominally equal an integer number of symbol periods, regardless of the symbol rate in use. Stated more formally: let {Rᵢ} be the set of permissible RL symbol rates. Then,

T_{F}·Rᵢ is integer, ∀i

Any symbol rate is permissible as long as it is a rational multiple of every other permissible symbol rate.

FIG. 8 shows an example structure of a physical layer frame 120. The frame is designed to carry as large a payload as possible, with a minimal amount of overhead, to maximise bandwidth efficiency of the return link. It is possible for an embodiment of the frame to contain payload data with no overhead at all. However, it is advantageous to include a small amount of overhead. A configurable number of null (zero energy) symbols 121 can be included at the beginning and, optionally, at the end of the frame 120. During a null symbol, no carrier is transmitted. The null symbols help to mitigate cross-terminal interference due to small mismatches in timing alignment with respect to frame boundaries. The preamble 122 consists of a configurable sequence of symbols. It is used in the receiver to assist carrier phase tracking and estimate thermal noise power density on the link. A codeword has a particular length (number of bits) and a symbol of a particular modulation scheme has a finite capacity (bits per symbol.) For some combinations of symbol rate plus modulation and coding scheme an amount of stuffing symbols may be required because the payload section of the frame (expressed in symbols) is not an integer multiple of the codeword length (also expressed in symbols). Advantageously, these stuffing symbols 123 are Inserted after the preamble 122, rather than at the end of the frame, because stuffing symbols do not carry useful data, and can be used to ‘absorb’ any remaining transient carrier sync effects which may occur immediately after the preamble 122. Finally, the remaining part of the frame contains an integer number of codewords 124. Each codeword consists of a number of transmission symbols. FIG. 8 is not drawn to scale. Typically, a frame has a length of the order of 1 second and the null symbols occupy a period of a few μs.

FIG. 9 shows an example BPSK symbol stream, and carrier phase trajectory θ(t). Two complete frames 131, 132 are shown, along with part of a third frame 133. Each new frame begins with a respective Start Of Frame (SOF) symbol 134, 135, 136, Each frame has the same duration T_{F}. In this example, the frames 131, 132, 133 each have a different symbol rate. Frame 132 has a lower symbol rate than frame 131, and frame 133 has a higher symbol rate than frame 131 and frame 132. It will be understood that FIG. 9 shows the baseband signal stream, and the symbols in each of frames 131, 132, 133 can be transmitted at different carrier frequencies. If, at the hub side of the link, the SOF symbols are received exactly at hub-time instants associated with a frame boundary, then the terminal is perfectly synchronised to the system heartbeat, which is the frame rate. Note that the carrier phase θ(t) follows a continuous trajectory with connected straight-line segments. The slope of the segments (thus the carrier frequency) is allowed to change exactly at SOF symbols 134-136.

FIG. 10 schematically shows a terminal 40 for use in the satellite transmission system. The terminal comprises an antenna 72 for receiving the forward link RF signal 31 and transmitting the return link RF signal 32, a receiver 80 and a transmitter 90. Antenna 72 typically down-converts the forward link RF signal 31 to an IF band and forwards this to the receiver 80. Receiver 80 receives the (down-converted) forward link signal 31 and performs demodulation and decoding of the received signal. Data is output 8.1. Receiver 80 extracts, from the forward link signal, information about the sequence of transmission, slots that has been allocated to the terminal on the returns link 32. This information 83 is received in <UPDATE> messages and forwarded to the controller 92. Receiver 80 also extracts, from the forward link signal, information 84 which instructs a change in transmission rate. This information 84 is received as an offset field of <UPDATE> messages and forwarded to the controller 92. Receiver 80 also extracts, from the forward link signal, information about the FW link transmission clock rate. Information 84, 86, and an output of a local oscillator 85, is applied to a frequency reference unit 93. Unit 93 maintains a stable clock rate effectively slaved to the HUB frequency reference which helps to ensure that the terminal 40 respects transmit regulations.

Advantageously, each terminal 40 generates a reverse link (RL) signal 32 in multiple stages. A first stage 94 generates a modulated signal comprising transmission symbols (commonly called baseband signal in the art) and a second stage 95 up-converts this generated signal to RF. Stage 94 is a wideband transmitter 95 which selectively transmits the transmission symbols on one (or more) of a set of frequency carriers used by the transmission scheme. Stage 94 dynamically adjusts the carrier frequency and symbol rate in a phase continuous fashion. The carrier frequency can vary within a frequency band. Frequency changes are synchronised to transmit symbol timing. Level adjustments in order to maintain a given target power spectral density across symbol frequency ‘jumps’ are also performed by stage 94, Stage 94 generates transmission symbols at a required rate. These symbols contain coded user data. Advantageously, the RF stage 95 is not dynamically adjusted and is programmed to statically transmit into the L-band frequency region that will result in the correct outdoor unit TX frequency range after up-conversion. Transmitter 90 comprises an input 91 for receiving data. Controller 92, and sequence information 83, determines the time and frequency band of each transmission slot. Controller 92, and sequence information 83, also determines the symbol rate to be used during each transmission slot. A store 96 stores a look-up table (LUT) of symbol rates and the corresponding number of transmission symbols. The LUT is used to convert the symbol rate, signalled in the <UPDATE> message, to a number of symbols that the terminal must transmit during the next frame.

FIG. 11 schematically shows, in more detail, apparatus provided at the hub 20 of the satellite transmission system. The hub 20 generates the forward link RF signal 31 and receives the return link RF signal 32. The actual transmission and reception of these signals at an antenna may occur at a ground station which Is located remotely from the hub 20, Hub comprises a transmitter 21 for generating the forward link signal 31 and a receiver 22 for receiving the return link signal 32. Transmitter 21 receives data for transmission and performs coding and modulation of the signal, as well as multiplexing of the signals destined for different terminals 40. Transmitter 21 also includes, in the forward link signal 31, information about the sequence of transmission slots that has been allocated by scheduler 26 to each terminal 40 on the return link 32. A stable frequency reference (e.g. local oscillator) is applied to the transmitter 21 and used by the transmitter to generate transmission symbols at a controlled rate on the forward link 31. Advantageously, there is a bank of RL receivers, with one RL receiver 22 dedicated to each active terminal 40 in the system. Receiver 22 comprises an input for receiving an RF signal (typically down-converted to an IF). A tuner 223 tunes to the particular frequency band known to be used by the terminal 40 at each instant in time. Symbol demodulation function 224 demodulates received transmission symbols at a required rate. This also Includes decoding received data. Controller 221 receives the sequence information from scheduler 26 and uses the sequence information to control the tuner 223 to adjust to the frequency band known to be used by each transmission slot of the particular terminal 40, at a time which is known to be the start time of the transmission slot. Controller 221 also controls the symbol demodulation function 224 to vary the symbol rate according to the sequence information. Scheduler 26 receives requests from active terminals which specify the transmission needs of the terminals. Scheduler 26 allocates a sequence of transmission slots to each active terminal based on their transmission needs, and may use various prioritisation criteria to fairly distribute resources among the terminals. Various scheduling algorithms are known in the art.

Advantageously, all terminals 40 change carrier frequency and/or symbol rate in a phase continuous fashion, or with a predictable and limited phase discontinuity. This makes it easier to fulfill transmit regulation requirements, because there are no abrupt changes in signal value, which would generate spurious (high energy) frequency components. This requirement allows -further simplifications to hub receiver design and allows return link efficiencies very close to satellite channel capacity.

In the system described above, a scheduler attempts to allocate each terminal a transmission slot which is matched to the bandwidth demands of the terminal at that time. Different portions of the frequency have slots of different bandwidth (e.g. in FIG. 5B slot 52 has a larger bandwidth than slots 51, 53.) If a terminal does not have any data to transmit, it can either be (i) allocated & transmission slot with a nominal bandwidth, or (ii) logged off, returning the terminal to state 102. Option (i) has an advantage in that it allows the terminal to continue transmitting, such that it can later make a request for bandwidth, and receive an allocation with minimal delay, without the need to log-on. Whether a terminal is operated using option (i) or (ii) will depend on factors such as the number of free transmission slots.

The embodiment described in detail is a dynamic scheme, where a terminal changes symbol rate and/or carrier frequency as instructed by the hub. A static scheme is also possible, where the RL frequency plan is never updated, in this alternative embodiment, there is no need for all terminals to he SOF-symbol-aligned. hi this alternative, the terminal can switch to normal frame mode at a (static) operational symbol rate after having transmitted a static default number of PRBS symbols also known to the hub. The result of this is that all terminals keep sending SOP symbols at some random time offset from the hub SOF. This does not harm individual communication between a terminal and the hub since it is sufficient that a RL receiver knows where to find the codewords in the received symbol stream, in practice, there is little cost involved in SOF-aligning all terminals, especially if the system also supports the dynamic scheme. Therefore, the system can SOF-align all terminals even in a static RL plan scenario, for the sake of a unified approach and reduced test space.

The system can have any one of the following topologies: star; multi-star; partly meshed star network where terminal-to-hub and terminal-to-terminal communication links can share bandwidth. The partly meshed star network has a ‘master’ hub and a plurality of slaving hubs/terminals with ‘remote’ RL receivers. All of the remote receivers synchronise to one common virtual time reference. The time reference can be Global Positioning System (GPS) time. Remote receivers obey commands sent by a scheduler in the master hub.

The invention is not limited to the embodiments described herein, which may be modified or varied without departing from the scope of the invention.

1-14. (canceled)

15. A method of operating a terminal in a wireless multiple access communication system comprising a forward link to the terminal and a return link from the terminal, wherein the return link uses a medium which is shared between terminals on the basis of time and frequency, the method comprising:
transmitting a return link signal from the terminal across a sequence of transmission slots, each transmission slot being defined as a time slot and carrier frequency, wherein carrier frequency and symbol rate can change between transmission slots, and wherein the return link signal is transmitted continuously across the sequence of transmission slots;
wherein the terminal can transmit, at one of a set of different symbol rates, the set of symbol rates such that each of the symbol rates has an integer number of symbols during a transmission slot, and wherein the terminal changes symbol rate at a start of a new transmission slot.

16. A method according to claim 35, further comprising receiving, on the forward link, information identifying a subsequent transmission slot, and wherein the information allows the terminal to determine a number of transmission symbols to be transmitted during the subsequent transmission slot.

17. A method according to claim 15, wherein the return link signal is transmitted in a phase continuous manner across the sequence of transmission slots.

18. A method according to claim 15, further comprising acquiring frequency synchronisation with the forward link and transmitting at a symbol rate and carrier frequency on the return link based on the acquired frequency synchronisation.

19. A method according to claim 18, further comprising acquiring synchronisation with a huh of the system by:
receiving, from the huh, an instruction to start transmitting identification symbols on the return link;
transmitting, on the return link, Identification symbols and counting the number of transmitted identification symbols;
receiving an instruction to begin transmitting a user data payload in a first transmission slot after a specified number of transmitted identification symbols; and
transmitting, in the first transmission slot, a user data payload after transmitting the specified number of identification symbols.

20. A method according to claim 18, wherein each terminal transmits a start of frame symbol at the start of each transmission slot, the method further comprising receiving an instruction to adjust the symbol rate on the return link in order to time align the start of frame symbol sent by the terminal with start of frame symbols sent by other terminals in the system.

21. A method of operating a hub of a wireless multiple access communication system comprising a forward link from the hub to terminals in the system and a return link from a terminal to the hub, wherein return links from terminals share a transmission medium which is divided on the basis of time and frequency, the method comprising, at the hub:
allocating a terminal in the system a sequence of transmission slots, each transmission slot being defined as a time slot and, carrier frequency, wherein carrier frequency and symbol rate can change between transmission slots;
allocating a return link receive function for the reception of the return link signal from each terminal in the network; and,
causing the receiver to change in carrier frequency substantially in synchronism with a change in the carrier frequency of the signal received from the terminal, wherein the return link signal is transmitted continuously across the sequence of transmission slots; and
wherein the terminal can transmit, at one of a set of different symbol rates, the set of symbol rates such that each of the symbol rates has an integer number of symbols during a transmission slot, and wherein the terminal changes symbol rate at a start of a new transmission slot.

22. A method according to claim 21 further comprising monitoring the timing of the terminal and transmitting an instruction to the terminal to modify the symbol rate without substantial interrupt of the return link signal.

23. A method according to claim 21, further comprising transmitting information to the terminal identifying a subsequent transmission slot, and wherein the information allows the terminal to determine a number of transmission symbols to be transmitted during the subsequent transmission, slot.

24. A method according to claim 23, further comprising periodically determining transmission needs of terminals in the system and transmitting the information identifying the sequence of transmission slots on the basis of the determined transmission needs and return link quality indicators such as signal-to-noise ratio and terminal power amplifier saturation.

25. A method according to claim 21, further comprising acquiring synchronisation with a terminal of the system by:
transmitting an Instruction to the terminal to start transmitting identification symbols on the return link;
receiving, on the return link, identification symbols transmitted by the terminal and counting the number of identification symbols received from the terminal;
determining a start time for the terminal to transmit user payload data in a first transmission slot based on a number of transmitted identification symbols;
transmitting an instruction to the terminal to begin transmitting user payload data in the first transmission slot after the determined number of identification symbols.

26. A wireless communication terminal for use in a wireless multiple access communication system comprising;
a receiver arranged to receive a forward link signal; and
a transmitter arranged to transmit a return link signal, wherein the return link uses a medium which is shared between terminals on the basis of time and frequency, and wherein the transmitter is arranged to transmit a return link signal from the terminal comprising a sequence of transmission slots, each transmission slot being defined as a time slot and, carrier frequency, wherein carrier frequency and symbol rate can change between transmission slots, and wherein the return link signal is transmitted continuously across the sequence of transmission slot; and
wherein the transmitter can transmit, at one of a set of different symbol rates, the set of symbol rates such that each of the symbol rates has art integer number of symbols during a transmission slot, and wherein the transmitter changes symbol rate at a start of a new transmission slot.

27. A wireless communication apparatus for use at a hub of a wireless multiple access communication system comprising:
a transmitter arranged to transmit a forward link to terminals in the system;
a receiver arranged to receive a return link signal from one of the terminals, wherein return link signals from terminals share a transmission medium which is divided on the basis of time and frequency:
a scheduling function arranged to schedule a sequence of transmission slots for the return link of each terminal, each transmission slot being defined as a time slot and, carrier frequency, wherein carrier frequency and symbol rate can change between transmission slots;
causing the receiver to change in frequency substantially in synchronism with a change in the frequency of the return link signal received from the terminal, wherein the return link signal is transmitted continuously across the sequence of transmission slots; and
wherein the terminal can transmit, at one of a set of different symbol rates, the set of symbol rates such that each of the symbol rates has an integer number of symbols during a transmission slot, and wherein the terminal changes symbol rate at a start of a new transmission slot.

28. Software comprising instructions which, when executed by a processor, cause the processor to perform the method according to claim 1.
